(19) United States
(12) Patent Application Publication
(10) Pub. No.: US 2004/0047988 A1
(43) Pub. Date: Mar. 11, 2004

(54) Poly(methylsilsesquioxane) copolymers and preparation method thereof

(76) Inventors: Jin-Kyu Lee, Seoul (KR); Hee-Woo Rhee, Seoul (KR); Kook-Heon Char, Seoul (KR); Do-Yeung Yoon, Seoul (KR)

Correspondence Address: MERCHANT & GOULD PC, P.O. BOX 2903, MINNEAPOLIS, MN, 55402-0903, US

(21) Appl. No.: 10/432,143

(22) PCT Filed: Nov. 16, 2001
(86) PCT No.: PCT/KR01/01958

(30) Foreign Application Priority Data
Nov. 17, 2000 (KR) 2000-68435

(51) Int. Cl. B05D 5/06

(52) U.S. Cl. 427/240; 427/164

(57) ABSTRACT

The present invention relates to polymethylsilsesquioxane copolymers, and methods for preparing the copolymers and low-dielectric PMSSQ coating films. Polymethylsilsesquioxane copolymer of the present invention is synthesized by a copolymerization reaction using a methyltrialkokxysilane [A: CH₃Si(OR)₃] and α,ω-bistrialkokxysilane compound [B: (RO)₃Si—X—Y—Si(OR)₃, wherein X and Y are identical or different hydrocarbon groups and are linked to each other by carbon] as a copolymerization monomer, and it contains Si—OH terminal group more than 10% in content, and has molecular weight ranging from 5,000 to 30,000. The coating film prepared from the low dielectric PMSSQ according to the present invention meets the two inevitable requirements for next generation semiconductor industry, i.e., mechanical strength (hardness 1.9 Gpa, Modulus 12 Gpa) and low dielectric property (<2.3).

### DESCRIPTION OF THE DRAWING

FIG. 1 shows the change of molecular weight of the polymethylsilsesquioxane (PMSSQ) crosslinked copolymer according to the present invention as a function of the amount (mol %) of bis(trimethoxysilyl)ethane (BTMSE) as a comonomer.

FIG. 2 shows the change of amount of end-group of the PMSSQ crosslinked copolymer according to the present invention as a function of the amount (mol %) of BTMSE as a comonomer.

FIG. 3 shows the change of mechanical property of the thin film of the PMSSQ crosslinked copolymer according to the present invention as a function of the amount (mol %) of BTMSE as a comonomer.

FIG. 4 depicts a graph showing the reduction of a dielectric constant of dielectric thin films as a function of the amount of porogen introduced into PMSSQ copolymer matrix containing 20 mol % of BTMSE according to the present invention.

### BACKGROUND OF THE INVENTION

1. Field of the Invention

The present invention relates to polymethylsilsesquioxane copolymers, and preparation methods for the copolymers and low-dielectric PMSSQ coating films.

2. Description of the Prior Art

Since semiconductor devices are becoming smaller and device-packing densities are rapidly increasing, both signal delays due to the combined resistance R and capacitance C (R×C) coupling and the crosstalk between the metal wirings have been found to cause a serious problem.

According to the International Technology Roadmap for Semiconductor industry, when the distance between the metal lines in the integrated circuit narrow downs to 0.10 μm around year 2003, the interconnect delay is believed to the dominant factor in determining the overall device cycle time.

In this circumstance, in addition to switching the metal interconnection from aluminum to a more conductive copper, the introduction of low-dielectric insulator coating materials into the integrated circuits becomes essential.

Previously, SiO₂, which has a dielectric constant of around 4.0, was used as a low-dielectric insulator. Under the circumstances described above, however, such material seems to reach a limitation as a low-dielectric insulator.

Many researchers have tried to develop low-dielectric materials; polysilsesquioxane, polyimide and PTFE {amorphous poly(tetrafluoroethylene)} are such examples.

Among these, polysilsesquioxanes with an empirical formula (RSiO_{3/2})ₙ, where R is hydrogen or an organic group, have been studied for many years since the first commercialization of silicate polymers as an electronic insulation material for high temperature application. Poly(phenylsilsesquioxane), PPSSQ, was the most widely studied material and many synthetic methods have been patented. Recently, the polysilsesquioxanes have once again attracted much attention as a promising candidate for a low dielectric insulator in the next-generation semiconductor industry.

In addition, many researchers have tried to decrease the dielectric constant of an insulator by uniformly incorporating air pores (k=1; the lowest dielectric constant) in nanometer size into insulating polymer materials, to eventually develop materials with a very low dielectric constant of 2.0 or below (e.g. Tanev, P. T.; Pinnavaia, T. J. Science 1995, 267, 865, Yang, H.; Coombs, N.; Ozin, G. A. J. Mater. Chem. 1998, 8, 1205 etc.).

Among many candidates for the insulators, the inorganic/organic polymer hybrid system shows quite interesting and promising results, where silicon-oxygen bond based insulating polymers such as polymethylsilsesquioxane (PMSSQ) are used as a matrix and organic oligomers (known as a porogen), which can be decomposed to form pores at high temperature, are introduced to generate pores within the matrix by controlling the formation of nano size phase separation of the two components.

PMSSQ has been well known as an insulating matrix owing to its inherent low dielectric constant (k=2.7-3.0), low moisture absorption, excellent thermal stability up to 500° C., and reasonable mechanical hardness.

Synthetic methods for preparing soluble and stable PMSSQs by acid or base catalyzed hydrolytic polymerization of methyltrichlorosilane (MeSiCl₃) or methyltrialkoxysilane {MeSi(OR)₃} have been studied since the early patent publication by Japan Synthetic Rubber (JSR) in 1978.

In such methods, the synthesized PMSSQs are used without purification or separation. And, it has not yet been understood well enough how to control the molecular weight over a wide range as well as the amount and nature of unreacted functional end groups, which are believed to be quite important for the formation of nanometer size pores and the mechanical properties of final thin film insulator.

In previous studies, synthetic methods were introduced that the molecular weight and the end-group (Si—OH) of PMSSQ were controlled using the molar ratios of water/monomer and/or acid catalyst/monomer (Lee, J.-K.; Char, K.; Rhee, H.-W.,; Ro, H. W.; Yoo, D. Y; Yoon, D. Y. Polymer 2001, 42, 9085). During the synthesis reaction of PMSSQ, hydrolysis and condensation occur at the same time, and an equilibrium state exists between the water and the polymer.

If all the active functional groups of the monomer participate in the polymerization reaction, it leads to generation of insoluble gels in any solvent and precludes a thin film coating. Therefore, the level of condensation is controlled to stop the polymerization reaction at a soluble sol state, in which considerable amounts of Si—OH group remain.

According to previous studies, the molecular weight of PMSSQ increases as the amount of the water increases, and decreases continuously after reaching a maximum value. On the contrary, the amount of functional end-group (Si—OH) of PMSSQ decreases as the amount of the water increases and increases continuously after reaching a minimum value.

Accordingly, the molecular weight of PMSSQ is inversely proportional to the amount of functional end groups.

Therefore, increase in molecular weight of the PMSSQ to improve its mechanical properties leads to poor miscibility with porogen due to the decrease in the amount of functional end groups. On the other hand, if the amount of the terminal group of PMSSQ is increased to achieve good miscibility with porogen, very low molecular weight polymer is obtained and thin film of this polymer seldom exhibit good mechanical properties.

It is believed that the amount of Si—OH in PMSSQ should be 10% or more per Si-atom to properly interact with porogen such as polycaprolactone (PCL) to form nanometer size air pores.

TABLE 1
The molecular weight and the amount of the end groups of PMSSQ as a function
of the molar ratio (R₂) of water to monomer.

| Molar ratio of water | | | | | | | |
|---|---|---|---|---|---|---|---|
| to MTMS | 1.3 | 1.6 | 1.9 | 2.2 | 2.5 | 2.7 | 3.0 |
| Molecular weight | | | | | | | |
| Mw | 2221 | 3631 | 5469 | 8635 | 4062 | 3493 | 2538 |
| Mn | 1220 | 1754 | 2172 | 2356 | 1781 | 1707 | 1364 |
| Polydiversity | 1.7 | 2.0 | 2.5 | 3.7 | 2.3 | 2.0 | 1.8 |
| Index | | | | | | | |
| ¹H-NMR | | | | | | | |
| Si—CH₃ | 100 | 100 | 100 | 100 | 100 | 100 | 100 |
| Si—OCH₃ | 12.5 | 5.3 | 3.6 | 1.2 | 1.4 | 1.1 | 1.4 |
| Si—OH | 6.3 | 6.9 | 5.0 | 3.5 | 6.8 | 7.3 | 9.1 |
| End groups (%) | 15.5 | 12.3 | 7.6 | 4.8 | 7.6 | 7.8 | 9.5 |
| Si—OH (%) | 5.0 | 6.3 | 2.1 | 4.3 | 6.2 | 6.7 | 8.2 |

(The molecular weights were normalized by molecular weight of the standard polystyrene polymer)

According to the results in table 1, the end group (Si—OH) contents of the synthesized PMSSQs in the soluble solid state are generally 10% or less.

If the level of condensation is controlled to synthesize PMSSQ with more than 10% of the Si—OH end group, the molecular weight of the PMSSQ becomes too low, resulting in poor mechanical properties.

Semiconductor electronic materials undergo the Chemical Mechanical Polishing (CMP) in actual process and are required to have 10⁻¹¹ m/s or less crack propagation velocity on film thickness of 800 nm for commercialization. However, PMSSQ homopolymer obtained from MTMS alone does not meet such a requirement for the reasons stated above.

In summary, PMSSQ homopolymer prepared using the previous synthetic method contains only a small amount of the Si—OH end group and the number of air pores generated in the polymer are not sufficient to obtain the dielectric constant below 2.5. Further, it has inappropriate mechanical properties and thus cannot be adopted in actual semiconductor manufacturing processes.

### DISCLOSURE OF INVENTION

A purpose of the present invention is to provide an effective method to synthesize soluble polymethylsilsesquioxanes with sufficient amounts of end groups (Si—OH) and high molecular weights to obtain an excellent mechanical property.

In order to achieve the above objective, the present invention provides a method for preparing polymethylsilsesquioxane copolymers which have crosslinkable repeat units of organosilicone, 10% or more silanol end groups (Si—OH) and an average molecular weight within the range of 5,000-30,000,

comprising the step of copolymerizing the following monomers in organic solvent/water with acid catalyst

(a) methyltrialkoxysilane [A: CH₃Si(OR)₃] represented by Formula 1, and

(b) 1 or 2 monomers with α,ω-bistrialkoxysilyl compound [B: (RO)₃Si—X—Y—Si(OR)₃, wherein X and Y are identical or different hydrocarbons and are linked to each other by carbon] represented by Formula 2 and/or bis(methyldimethoxysilyl)ethane [(MeO)₂MeSi—(CH₂)₂—SiMe(OMe)₂].

The present invention further provides the method for preparing polymethylsilsesquioxane copolymers wherein the R is CH₃— or CH₃CH₂— and the —X-Y— is —CH₂—CH₂—.

The present invention further provides the method wherein the content of the α,ω-bistrialkoxysilyl compound and/or bis(methyldimethoxysilyl)ethane in the copolymer is 1-50 mol %.

The present invention further provides polymethylsilsesquioxane prepared according to the above methods.

The present invention further provides a method for preparing low-dielectric nanoporous polymethylsilsesquioxane coating film, by coating a mixture of porogen and polymethylsilsesquioxane copolymer according to one of the above methods in an organic solvent onto a substrate.

The present invention further provides the method wherein the coating process is carried out by spin coating.

The present invention further provides the above method wherein the organic solvent is one of the generally available ones such as methylisobutylketone, PM acetate, acetone, chloroform, toluene, methylpyrrolidone (NMP), dimethylsulfoxide and tetrahydrofuran.

The present invention further provides the method wherein the porogen is polyacrylate such as polycaprolacton (PCL), polyether and polyhydroxyethylmetacrylate.

The present invention further provides the method wherein the substrate is a glass or quartz substrate for optical instruments which require high surface hardness or a substrate for semiconductors which require low-dielectric properties.

The present invention further provides the method for preparing low-dielectric coating film having pores of 10 nm or less in size.

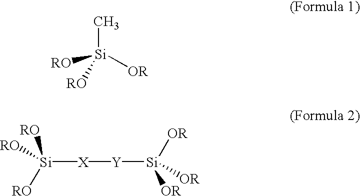

(Wherein X and Y are identical or different hydrocarbons and are linked to each other by carbon)

### EXAMPLES

I. Structural Characters of Copolymers Containing Crosslinkable Organosilicon Monomer and Their Mechanical and Electrical Properties Thereof

The analysis of the structure of PMSSQ homopolymer by GPLDI-TOF-MS (Graphite Plate Laser Desorption/Ionization Time-of-Flight Mass Spectroscopy), shows that the molecular weight of the polymer increases while forming a cage structure or partial cage structure instead of an amorphous structure.

It has been revealed that such cage structures decrease the mechanical strength of polymer thin films (Kim, H. J.; J. K.; Park, S. J.; Ro, H. W.; Yoo, D. Y.; Yoon, D. Y. Anal. Chem. 2000, 72, 5673). Owing to this cage structure formation, the PMSSQ homopolymer has a much lower dielectric constant (k=2.7-2.8) and a lower Elastic Modulus (E=˜3 GPa) compared to the silica with irregular amorphous structure (SiO₂; k=4.0, E=72 GPa).

If it is possible to change the structure of the growing polymer into an amorphous structure from a cage structure using a proper comonomer, the resultant copolymer may exhibit a significantly improved mechanical strength, though such a structural change leads to a slight increase in the dielectric constant of the copolymer.

It is expected that due to the larger number of functional end groups and higher crosslinking density in the crosslinkable organosilicon comonomer of formula 2, compared to the homopolymer of MTMS (R=Methyl in formula 1), the molecular weight of the copolymer during sol-gel reaction would increase, and the velocity of the reaction in the intermolecular-condensation would be faster than that of the intramolecular-condensation. Further, the improved intermolecular-condensation is expected to minimize the formation of the cage structure.

The change in number of the methylene group (—CH₂—), which links two silicon reaction sites, will change the mechanical properties of the organic polymer copolymerized with MTMS, depending on the interaction between the two silicon sites. The following explain this in detail.

If n=1 or 2, the two silicon sites are closely connected to each other and cannot react independently. Thus, the addition of the crosslikable organosilicon comonomer results in a sharp increase in crosslinking density of the copolymer.

In particular, such an effect is maximized when n=2. In the measured results, the dielectric constant of the copolymer is k=2.9-3.1 which is slightly higher than that of the PMSSQ homopolymer and the elastic modulus is E=˜10 GPa which is three times higher than that of the PMSSQ homopolymer, as expected.

Moreover, the measured value of crack velocity in water, which is very important in the semiconductor process, is below 10⁻¹¹ m/s in a thin film in 1.0 μm thickness and meets the basic strength requirement for the CMP process, established by SEMATECH (USA semiconductor material estimation institute).

When n=3, however, the expected properties are not observed. It is assumed that the two silicon sites at both ends can act independently due to the sufficient flexibility of the three methylene groups and a new cage structure is formed as shown in formula 3.

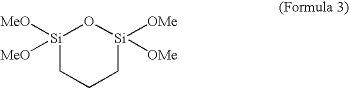

When n=3 or more, such tendency increases significantly. When n=6, a small amount of the comonomer rapidly increases the crosslinking density. As the amount of the comonomer added is increased, however, only a little improvement in the mechanical properties can be observed compared to the PMSSQ homopolymer.

A study on the correlation between mechanical property and the number of methylene functional group shows that the monomer BTMSE (bis (trimethoxysilyl)ethane, formula 4), where n=2, is most effective. The following table 2 compares the properties of the co-polymers with n=2 and n=6.

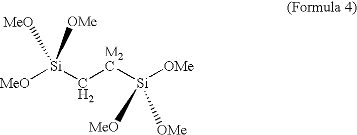

TABLE 2
Mechanical properties of organosilicate polymer as a function of the
number of methylene (—CH₂—) functional group.

| | Content of BTMSE in | | | | | | |
|---|---|---|---|---|---|---|---|
| n | copolymers (mol %) | 0 | 5 | 10 | 15 | 20 | 25 |
| 2 | Elastic Modulus | 3.0 | 5.1 | 6.2 | 7.9 | 11.1 | 12.0 |
| | Hardness | 0.4 | 0.8 | 1.1 | 1.2 | 1.7 | 1.9 |
| 6 | Elastic Modulus | 3.0 | 9.0 | 8.1 | 5.3 | 5.1 | 5.1 |
| | Hardness | 0.3 | 1.4 | 1.0 | 0.6 | 0.6 | 0.6 |

II. Mechanical and Electrical Properties of the Copolymer as a Function of the Amount of the Crosslinkable Comonomer.

As mentioned above, crosslinkable organosilicon comonomer has higher crosslinking density compared with MTMS, which induces the molecular weight of the polymer during sol-gel reaction to increase and the velocity of the reaction in the intermolecular-condensation to become faster than that of intramolecular-condensation. Thus, the resultant copolymer contains many more ‘polar end groups’ than the PMSSQ homopolymer.

These polar end groups enable PMSSQ to mix well with a large amount of porogen and leads to high porosity in the coated polymer thin film. Their polarizability, however, adversely increases the dielectric constant of the polymer thin film. Therefore, it is required to properly control the content of crosslinkable organosilicon comonomer to obtain copolymer with optimal amount of polar end groups.

The following Tables 3 and 4 respectively represent the molecular weights and the contents of functional end groups of the crosslinked copolymer with increased amount of BTMSE (n=2) from 0 to 25 mol %.

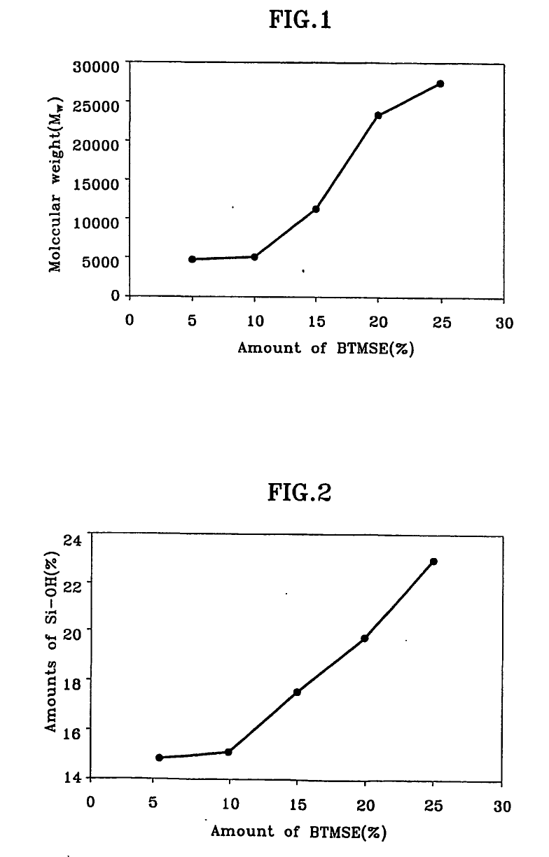

FIGS. 1 and 2 depict Tables 3 and 4 respectively. The results were obtained using the following experimental method.

A reactor equipped with a reflux condenser under nitrogen atmosphere was set up at 1 atm. 10 g of THF as a solvent and mixtures of MTMS and BTMSE with molar ratios (MTMS/BTMSE) of 95:5, 90:10, 85:15, 80:20 and 75:25 were added into the reactor. After fixing the molar ratios of ‘hydrochloric acid as a catalyst to the monomer mixture’ and ‘water to the monomer mixture’ at 0.03 and 10.0, respectively, the reaction was carried out at 65° C. under reflux.

TABLE 3
Variation of molecular weights of the crosslinked copolymer depending
on the molar ratio of the monomers.

| MTMS:BTMSE | Mw | Mn | PDI | State of the product |
|---|---|---|---|---|
| 95:5 | 4800 | 2400 | 2.0 | Soluble solid |
| 90:10 | 5200 | 2700 | 1.9 | Soluble solid |
| 85:15 | 11400 | 4100 | 2.8 | Soluble solid |
| 80:20 | 23400 | 6100 | 3.8 | Soluble solid |
| 75:25 | 27400 | 6500 | 4.2 | Soluble solid |

(The molecular weights were normalized by the molecular weight of the standard polystyrene polymer)

TABLE 4
Variation of the amount of Si—OH in the crosslinked copolymer depending on the molar
ratios of the monomers.

| MTMS:BTMSE | Si—CH₃ | Si—CH₂ | Si—OCH₃ | Si—OH | # of total Si atom | Si—OH (%) |
|---|---|---|---|---|---|---|
| 95:5 | 75.3 | 3.8 | 1.0 | 4.0 | 27.0 | 14.8 |
| 90:10 | 107.3 | 16.0 | 1.0 | 6.6 | 43.7 | 15.1 |
| 85:15 | 39.0 | 9.2 | 1.0 | 3.1 | 17.6 | 17.6 |
| 80:20 | 29.7 | 9.5 | 1.0 | 2.9 | 14.7 | 19.8 |
| 75:25 | 16.9 | 8.8 | 1.0 | 2.3 | 10.0 | 23.0 |

*The values correlate to the amounts of hydrogen atoms of the respective functional groups measured by ¹H-NMR.
*total number of Si atom = Si—CH₃/3 + Si—CH₂/2
*Si—OH (%) = Si—OH/total number of Si atom

As shown in the above tables, the molecular weights and the amounts of end groups of the crosslinked copolymers increased with increased amount of BTMSE. Polymer thin films can be readily obtained with a good reproducibility when the amount of silanol end group in copolymer is more than 14% and molecular weights of the copolymer is between 5,000 and 30,000.

Such crosslinked copolymers have good solubility in general organic solvents such as acetone, chloroform, toluene, tetrahydrofuran, PM acetate, methylisobutylketone (MIBK), methylpyrrolidinone (NMP), and dimethylsulfoxide (DMSO), and poor solubility in water and alcohol.

By dissolving the PMSSQ copolymers in MIBK and carrying out spin coating, transparent thin films were readily produced. The transparency of the produced thin film remained unchanged after the heat treatment at the temperature of 430° C., and dielectric constants of these thin films were between 2.8 and 3.4, which is equal to the existing insulating materials.

These values were measured before incorporation of nanometer size pores. Considering that the dielectric constant decreases after incorporation of the pores, the low dielectric property of the coating film according to the present invention was found to be excellent.

Subsequently, the mechanical properties of the copolymers were evaluated using Nanoindentor. The hardness and modulus of the crosslinked copolymers were 1.9 GPa and 12 GPa, respectively, while those of PMSSQ homopolymers were 0.4 GPa and 3.0 GPa.

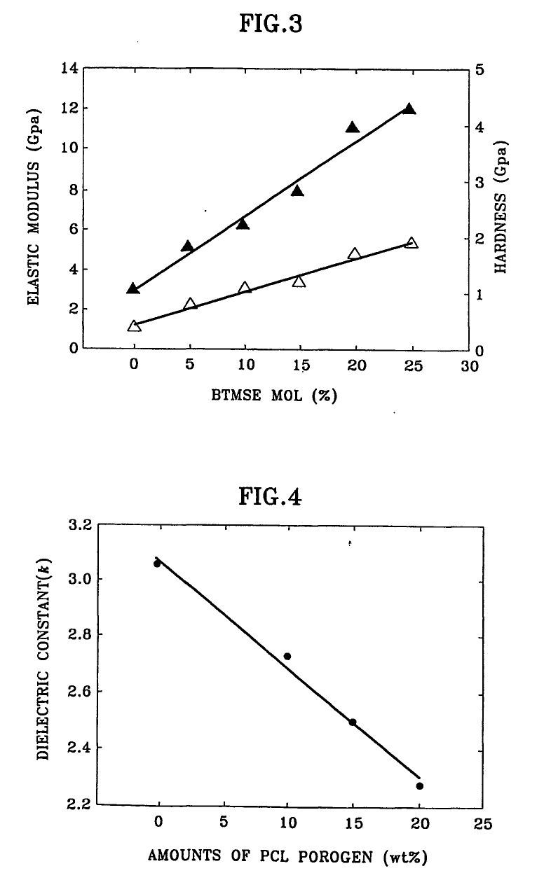

PMSSQ copolymer with such mechanical strengths satisfies the minimum requirement for its application to semiconductor process and can be utilized to make up for the shortcomings of the PMSSQ homopolymer (table 5 and FIG. 3).

Crack propagation velocity in water was 10⁻¹¹ m/s or lower up to film thickness of 1 μm, which also confirms a satisfactory mechanical property of the copolymer.

Table 5 shows the amounts of polar end groups in the copolymer and mechanical properties of the copolymer measured by the nanoindentor depending on the changed amount of BTMSE crosslinkable comonomer.

The electrical properties of the copolymer, i.e., dielectric constants gradually increased with increase in the amount of polar end groups. Table 6 shows this result.

TABLE 5
The amount of the polar end group and mechanical property of the
copolymer depending on the amount of the BTMSE comonomer

| BTMSE mol % | | | |
|---|---|---|---|
| in the copolymer | Si—OH (%)^{a} | Elastic Modulus (GPa) | Hardness (GPa) |
| 0^{b} | 9.0 | 3.0 | 0.4 |
| 5 | 14.8 | 5.1 | 0.8 |
| 10 | 15.1 | 6.2 | 1.1 |
| 15 | 17.6 | 7.9 | 1.2 |
| 20 | 19.8 | 11.1 | 1.7 |
| 25 | 23.0 | 12.0 | 1.9 |

^{a}The value was calculated by quantification from the ¹H NMR measurement.
^{b}The value was measured for the MTMS homopolymer.

TABLE 6
The amount of the polar end group and the electrical property of the
copolymer depending on the amount of the BTMSE comonomer

| BTMSE mol % in the copolymer | Si—OH (%)^{a} | Dielectric constant^{b} |
|---|---|---|
| 0^{c} | 8.6 | 2.70 ± 0.02 |
| 5 | 13.2 | 2.92 ± 0.08 |
| 10 | 14.7 | 2.96 ± 0.05 |
| 10^{d} | 10.0 | 2.65 ± 0.04 |
| 20 | 19.8 | 3.37 ± 0.08 |

^{a}The value was calculated by quantification from the ¹H NMR measurement.
^{b}The value was determined by the Metal-Insulator-Metal (MIM) method.
^{c}A commercial PMSSQ homopolymer
^{d}The polymer with a reduced amount of the polar end group obtained by changing the reaction condition to evaluate the influence of the polar end group.

These studies on the basic physical properties confirmed that the increased amount of the BTMSE comonomer improves the mechanical properties but lowers the electrical property.

III. The Miscibility Between BTMSE Copolymer and Porogen, and Electrical Properties of the Obtained Porous Thin Film.

Use of the BTMSE comonomer, which has a higher crosslinking density compared to MTMS and prefers intermolecular condensation to intramolecular condensation, increases the molecular weight of the copolymer in the polymerization process and the amount of the polar end group. Therefore, the obtained copolymer has an excellent miscibility with polymetacrylate porogen such as polycaprolactone (PCL), poly(ethyleneoxide) (PEO) and polyhydroxyethylmetaacrylate (PHEMA), and forms a homogeneous thin film which has a high porosity and generates no crack or turbidity even after heat-treatment.

The following table 7 represents the electrical property of a porous thin films produced with the mixture of PMSSQ copolymer with 20 mol % BTMSE and a predetermined amount of PCL porogen.

TABLE 7
The variation of dielectric constant of porous thin film depending
on the amount of polycaprolactone (PCL) porogen.

| | | PCL porogen | |
|---|---|---|---|
| Copolymer | Si—OH (%) | (weight %) | Dielectric constant |
| BTMSE 20 mol % | 19.8 | 0 | 3.37 ± 0.08 |
| | 19.8 | 10 | 3.09 ± 0.05 |
| | 19.8 | 20 | 2.87 ± 0.14 |
| | 19.8 | 30 | 2.70 ± 0.04 |
| BTMSE 20 mol % | 15.0 | 0 | 3.05 ± 0107 |
| | 15.0 | 10 | 2.73 ± 0.07 |
| | 15.0 | 15 | 2.50 ± 0.05 |
| | 15.0 | 20 | 2.28 ± 0.06 |

When the homogeneous porous thin film is produced with the porogen incorporated into the polymer matrix, the size and the shape of the pores in the thin films have a great influence on mechanical properties of the thin films. In addition, the these characters of the pores are key factors in determining the porosity of the porous thin film.

If the pores form an interconnected channel-shaped open pore or become much larger in size (>10 nm) than the distance between the metal wires, the metal can be deposited directly into the pore during the metal wiring process and eventually dielectric layer will lose its insulating function.

The above copolymers mix well with porogen due to the properly controlled amount of functional end groups and other structural factors. Therefore, the pore sizes of the copolymer become too small to be observed by the measuring instrument such as AFM, FE-SEM and TEM. Instead, they can be measured by PALS (Positronium Annihilation Lifetime Spectroscopy), which can observe the size and distribution of the nanometer size pores.

The pore sizes measured using PALS of 40 wt % or less of the PCL porogen incorporated into BTMSE 20 mol % copolymer, were no larger than 3 nm and had a porosity of 35% or higher.

Furthermore, as the amount of PCL porogen was increased, the obtained pore size also increased within the size range of 1.8-3.0 nm. It was also found that the use of the porogen having an optimized miscibility with BTMSE copolymer increased the porosity up to 80% and reduced the dielectric constant below 2.0.

As described above, the present invention is significant because the coating film according to the present invention has a low dielectric constant and excellent mechanical properties at the same time. Further, the most important point is that the present invention proved that the mechanical and electrical properties can be controlled by regulating the amount of end group and the molecular weight

IV. Control of the Silicon Site Reactivity in the Crosslinkable Organosilicon Comonomer

On the other hand, it was found that the organosilicon comonomer has 3 methoxy groups at each silicon site and thus the electric property of the crosslinked copolymer using this comonomer was slightly unsatisfactory. Therefore, we investigated a method to reduce the number of polar functional groups at the silicon site while minimizing the structural change in the obtained copolymer. Table 8 shows the component and mechanical property of the copolymer of MTMS and newly synthesized BMDMSE (bis(methyldimethoxysilyl)ethane), (MeO)₂MeSi—(CH₂)₂—SiMe(OMe)₂.

TABLE 8
The component and mechanical property of BMDMSE copolymer

| BMDMSE mol % | Si—OH (%) | Elastic Modulus (GPa) | Hardness (GPa) |
|---|---|---|---|
| 0^{b} | 9.0 | 3.0 | 0.40 |
| 5 | 16.1 | — | — |
| 10 | 13.0 | 3.5 | 0.58 |
| 10^{b} | 29.7 | 4.1 | 0.77 |
| 15 | 14.2 | — | — |
| 20 | 14.6 | — | — |

^{a}Commercialized PMSSQ homopolymer
^{b}Polymer with increased amount of end group by varying the reaction condition to confirm the influence of the polar end group

As shown in the experimental result, when the number of the reactive sites at both silicons of the monomer decreases, the amount of polar end group also decreases. In this case, the mechanical property of the BMDMSE copolymer tends to be lower than that of the BTMSE copolymer.

However, BMDMSE copolymers had better mechanical properties when compared to the PMSSQ homopolymer. It is assumed that the BMDMSE comonomer prevents the formation of cage-shaped structure in the copolymer.

### INDUSTRIAL APPLICABILITY

The coating film prepared from the low dielectric PMSSQ copolymer according to the present invention meets the two essential requirements for the next generation semiconductor industry, i.e., mechanical strength and low dielectric property.

The present invention provides preparation methods to reproducibly control the amount of polar end group and the molecular weight of the copolymer, and enables to prepare coating films having the abovementioned property, desired dielectric constant, and mechanical strength.

1. A method for preparing a polymethylsilsesquioxane copolymer which has crosslinkable repeat units of organosilicon, 10% or more silanol end group (Si—OH) and an average molecular weight within the range of 5,000-30,000,
comprising the step of copolymerizing the following monomers in organic solvent/water with acid catalyst
(a) methyltrialkoxysilane [A: CH₃Si(OR)₃] represented by Formula 1, and
(b) 1 or 2 monomers with α,ω-bistrialkoxysilyl compound [B: (RO)₃Si—X—Y—Si(OR)₃, wherein X and Y are identical or different hydrocarbon and are linked to each other by carbon] represented by Formula 2 and/or bis(methyldimethoxysilyl)ethane [(MeO)₂MeSi—(CH₂)₂—SiMe(OMe)₂].

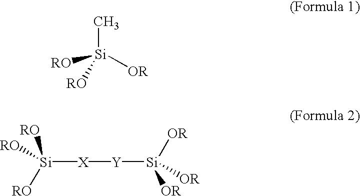

2. The method according to claim 1, wherein the R is CH₃— or CH₃CH₂— and the —X—Y— is —CH₂—CH₂—.

3. The method according to claims 1 or 2, wherein the content of the α,ω-bistrialkoxysilyl compound and/or bis(methyldimethoxysilyl)ethane in the copolymer is 1-50 mol %.

4. A polymethylsilsesquioxane prepared according to claims 1 or 2.

5. A method for preparing low-dielectric nanoporous polymethylsilsesquioxane coating films by coating a mixture of porogen and the polymethylsilsesquioxane copolymer according to claim 4 in an organic solvent onto a substrate.

6. The method according to claim 5, wherein the coating process is carried out by spin coating.

7. The method according to claim 5, wherein the organic solvent is one of the generally available organic solvents such as methylisobutylketone, PM acetate, acetone, chloroform, toluene, methylpyrrolidone (NMP), dimethylsulfoxide and tetrahydrofuran.

8. The method according to claim 5, wherein the porogen is polyacrylate such as polycaprolacton (PCL), polyether and polyhydroxyethylmetacrylate.

9. The method according to claim 5, wherein the substrate is a glass or quartz substrate for optical instruments requiring a high surface hardness or a substrate for semiconductors requiring a low-dielectric property.

10. A low-dielectric coating film having pores of 10 nm or less in size, prepared according to one of claims 5 to 9.

11. A method for preparing a polymethylsilsesquioxane crosslinked-copolymer, comprising the step of copolymerizing the following monomers in organic solvent/water with acid catalyst
(a) methyltrialkoxysilane[A: CH₃Si(OR)₃] represented by Formula 1, and
(b) 1 or 2 monomers with α,ω-bistrialkoxysilyl compound [B: (RO)₃Si—X—Y—Si(OR)₃, wherein X and Y are identical or different hydrocarbon and linked to each other by carbon] represented by Formula 2 and/or bis(methyldimethoxysilyl)ethane [(MeO)₂MeSi—(CH₂)₂—SiMe(OMe)₂], wherein the content of silanol end group (Si—OH) and the molecular weight of the copolymer is regulated by changing the mixing ratio of the monomers.
